(19) United States
(12) Patent Application Publication
(10) Pub. No.: US 2026/0117895 A1
(43) Pub. Date: Apr. 30, 2026

(54) Flexible pipe and a method of manufacturing a flexible pipe

(71) Applicant: Polyflow LLC, Midland, TX (US)

(72) Inventors: Zhimin TAN, Katy, TX (US); Jeffrey Kenneth SHORTER, Magnolia, TX (US); Malcolm Werner Kurt ROSENOW, Aiken, SC (US); Linfa ZHU, Houston, TX (US)

(73) Assignee: Polyflow LLC, Midland, TX (US)

(21) Appl. No.: 18/929,504

(22) Filed: Oct. 28, 2024

(51) Int. Cl. F16L 11/08; B29C 48/00; B29C 48/07; B29L 7/00

(52) U.S. Cl. CPC F16L 11/081; B29C 48/022; B29C 48/07; B29L 2007/007

(57) ABSTRACT

There is disclosed a flexible pipe for conveying oil and gas field fluids. The pipe comprises a pipe body comprising a first pipe layer formed of a plurality of metallic wires embedded in a composite, the composite comprising a thermoplastic matrix material and a reinforcement dispersed therein. A heat distortion temperature of the composite is at least 200° F. (˜90 °C.) when tested in accordance with ASTM D648 using an outer fibre stress of 0.455 MPa.

### TECHNICAL FIELD

The invention relates to a flexible pipe for conveying oil and gas field fluids, in particular an unbonded reinforced thermoplastic pipe. The invention also relates to a method of manufacturing such a pipe.

### BACKGROUND

Unbonded reinforced thermoplastic pipe (RTP) is a flexible, high-performance pipe typically used in oil and gas applications for transporting fluids, including hydrocarbons, water, and gas. Unlike traditional rigid pipelines, RTP comprises multiple layers, each serving a distinct purpose: an inner layer provides fluid containment; a reinforcement layer surrounds the inner layer and resists mechanical loads, including tensile loads and internal pressure; and an outer layer surrounds the reinforcement layer and protects the pipe from external damage and environmental factors. The term “unbonded” refers to the fact that the layers of the pipe are not adhesively, or otherwise, bonded to one another.

The reinforcement layer is typically composed of metallic wires and a thermoplastic matrix material, in which the metallic wires are embedded. The metallic wires, often made from materials such as carbon steel or stainless steel, provide high tensile strength and stiffness. The thermoplastic matrix material, commonly composed of materials such as polyethylene (PE) or polypropylene (PP), encapsulates the metallic wires, holding the wires in place and protecting them from environmental exposure, thereby providing a barrier against corrosion, chemicals, and moisture, which could otherwise degrade the metal over time. Together, the metallic wires and thermoplastic matrix form a composite reinforcement layer that balances strength, flexibility, and durability, making RTP suitable for a wide range of applications, from onshore pipelines to subsea installations. However, due to the differing material properties of metal and thermoplastic, such as thermal expansion and flexibility, careful design and material selection are critical to mitigate potential issues like delamination and creep.

It is an object of embodiments of the invention to provide an improved flexible pipe and method of making the same, and/or at least mitigate one or more problems associated with known arrangements.

### SUMMARY OF THE INVENTION

According to an aspect of the invention, there is provided a flexible pipe for conveying oil and gas field fluids, the pipe comprising a pipe body comprising a first pipe layer formed of a plurality of metallic wires embedded in a composite, the composite comprising a thermoplastic matrix material and a reinforcement dispersed therein. A heat distortion temperature of the composite may be at least 200° F. (˜90° C.) when tested in accordance with ASTM D648 using an outer fibre stress of 0.455 MPa.

By including the reinforcement in the thermoplastic matrix material the material properties thereof may be adapted, or controlled, e.g., Young's modulus and strength may be increased. Such adaption may allow for matching, or at least minimising the difference between, the material properties of the metallic wires and thermoplastic matrix material—better aligning of the material properties of the metallic wires and the thermoplastic matric material has be found to mitigate potential issues, including thermal expansion mismatch, bonding issues, stress distribution, and creep. The arrangement may therefore improve failure resistance of the pipe body, and hence the pipe, particularly at elevated temperatures since the reinforcement may increase the heat-resistance of the composite. Load transfer efficiency from the pipe body to an end fitting may be improved. Benefits may also by seen in manufacturing, e.g., allowing more uniform embedding of the wires and avoiding defects like voids, which can arise from residual stresses induced in the materials during manufacture.

In certain embodiments, the reinforcement may comprise at least one of a plurality of long fibres having a fibre length greater than 1 mm and/or a plurality of short fibres having a fibre length of up to 1 mm. The plurality of short fibres and/or long fibres may comprise one of (including one or more of) aramid fibres, glass fibres, basalt fibres and carbon fibres. Additionally, or alternatively, the thermoplastic matrix material may comprise one of a polyvinylidene fluoride, a polyethylene, a polyphenylene sulphide, a polypropylene, a thermoplastic elastomer, and a polyamide.

In certain embodiments, the first pipe layer may formed of one or more helically wrapped tapes formed of the plurality of metallic wires embedded in the composite. At least two of the helically wrapped tapes may form respective sub-layers to form the first pipe layer, the sub-layers being wound in opposing helical directions.

In certain embodiments, the pipe body may comprise a second pipe layer disposed radially inward of the first pipe layer. The second pipe layer may be a polymeric pipe layer and/or provide an impervious liner layer. Additionally, or alternatively, the pipe body may comprise a third pipe layer disposed radially outward of the first pipe layer. The third pipe layer may be a polymeric pipe layer and/or provide a cover layer.

In certain embodiments, the pipe comprises an end fitting to which a first end of the pipe body is connected. The end fitting may comprise a first and second tubular connector members disposed radially inward and outward of the first pipe layer, respectively, the first pipe layer being clamped between the first and second tubular connector members. The first and second tubular connector members may be disposed radially inward and outward of the pipe body, respectively,

According to another aspect of the invention, there is provided a use of a flexible pipe as described above as an onshore pipe to convey an oil field fluid or a gas field fluid, and wherein optionally the flexible pipe is a reinforced thermoplastic pipe, e.g., an unbonded reinforced thermoplastic pipe.

According to another aspect of the invention, there is provided a method of manufacturing a flexible pipe for conveying oil and gas field fluids, the method comprising: forming a flexible pipe as described above, the forming including extruding the composite using a mixture of pellets of the thermoplastic matrix material and the reinforcement. Extruding the composite may comprise extruding the composite to form a tape in which the plurality of metallic wires are embedded therein and extend along a length thereof.

### BRIEF DESCRIPTION OF THE DRAWINGS

Embodiments of the invention will now be described, by way of example only, with reference to the accompanying figures, in which:

FIG. 1 is a cross-sectional view of a flexible pipe according to an embodiment of the invention;

FIG. 2 is a cross-sectional view of a flexible pipe according to another embodiment of the invention; and

FIG. 3 is a cross-sectional view of a flexible pipe according to yet another embodiment of the invention.

### DETAILED DESCRIPTION OF EMBODIMENTS OF THE INVENTION

Generally, embodiments of the invention have application in oil and gas operations, e.g., for use as an onshore pipe and/or for conveying oil and gas field fluids, such fluids including one or more of gas (e.g., methane, ethane, hydrogen, and CO₂), hydrocarbon fluids (e.g., oil), water, or other fluids (e.g., slurry). Other applications are contemplated, including mining operations, water management, municipal utilities, and chemical processing. Moreover, embodiments of the invention may have particular application as RTP, including unbonded RTP, the properties of which—particularly flexibility, durability, and the ability to handle high pressures—make it an attractive option in various industrial applications. Unlike steel pipes, RTP does not corrode, making it suitable for transporting aggressive chemicals, saline water, and other corrosive substances.

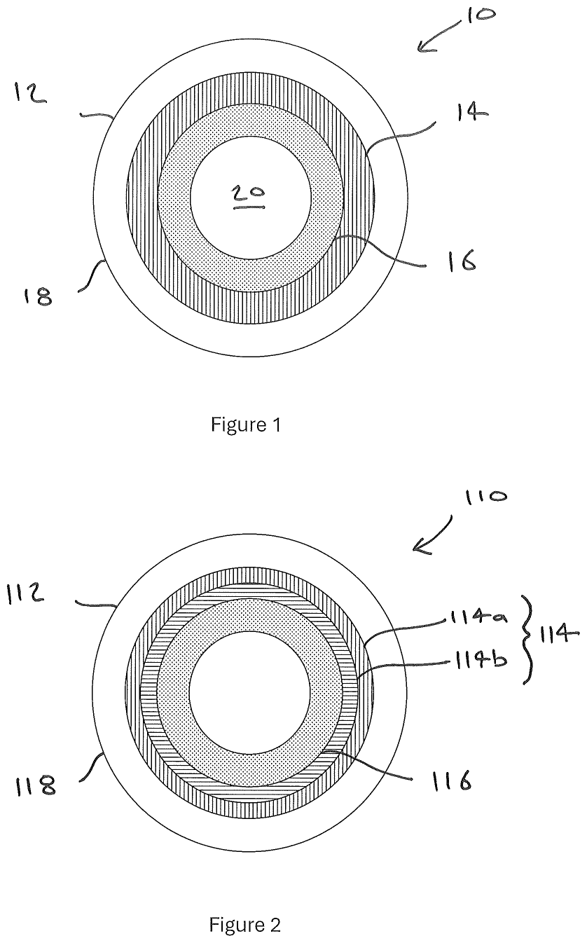

FIG. 1 shows a flexible pipe 10 according to an embodiment of the invention. The pipe 10 comprises a pipe body 12 having a first pipe layer 14, a second pipe layer 16 and a third pipe layer 18. The first pipe layer 14 is disposed intermediate the second and third pipe layers 16, 18. As such, the second pipe layer 16 is radially inward of the first pipe layer 14, and the third pipe layer 16 is radially outward of the first pipe layer 14. As in the illustrated embodiment, the first pipe layer 14 may be in direct contact with the second pipe layer 16 and/or the third pipe layer 18. Alternatively further pipe layers may be provided intermediate the first pipe layer 14 and the second pipe layer 16 and/or the third pipe layer 18. The pipe body 12 delimits a central bore 20 for conveying a fluid, e.g., a hydrocarbon fluid, along the length of the pipe body 12, and hence through, or along, the pipe 10.

The first pipe layer 14 is formed of a plurality of metallic wires, or strands, embedded in a composite, the composite comprising a thermoplastic matrix material and a reinforcement dispersed therein. Used herein, including in the appended claims, the feature “the reinforcement” is to be understood to be a reinforcement distinct from, and in addition to, the metallic wires, which may also be considered a reinforcement. The first pipe layer 14 provides a structural layer, or reinforcement layer, of the pipe body 12. The wires principally handle mechanical stresses, including internal pressure and tensile loads acting along the length of the pipe 10, while the thermoplastic matrix material principally protects the wires from environmental exposure. The wires may extend continuously through the first pipe layer 14, and/or along the total length thereof. The reinforcement dispersed within the thermoplastic matrix material alters the material properties thereof, relative to the matrix material without the reinforcement, as well as those the composite overall.

In particular, the reinforcement may increase heat-resistance of the composite. In certain embodiments, the heat distortion temperature of the composite layer is at least 200° F. (˜90° C.) as tested in accordance with ASTM D648 or ISO 75 using an outer fibre stress of 0.455 MPa. Testing in accordance with ASTM D648 requires that a test specimen (e.g., of the composite) is loaded in three-point bending in the edgewise direction. The temperature is increased at 2° C./min until the specimen deflects 0.25 mm. The test procedure of ISO 75 is similar to the test procedure defined in ASTM D648. The version of ASTM D648 referred to is D648-18, published April 2018, the contents of which is incorporated herein by reference.

The reinforcement may be provided by any suitable means. Suitable means for providing the reinforcement include a plurality of fibres, since fibres can be dispersed within the thermoplastic matrix material during manufacture. However, other materials are contemplated, including a plurality of polygonal particles (e.g., nanoparticles and/or microparticles), and/or two-dimensional materials (e.g., graphene). The plurality of fibres may comprise long fibres, which may have a fibre length greater than 1 mm and/or up to 100 mm, e.g., the long fibres may have a fibre length, or an average fibre length, of 25 mm. Additionally, or alternatively, the plurality of fibres may comprise short fibres. The short fibres may have a fibre length of at least 0.1 mm and/or up to 1 mm, e.g., the short fibres may have a fibre length, or an average fibre length of 0.7 mm. Additionally, or alternatively, the reinforcement may comprise any suitable material. Suitable materials include aramid fibres, glass fibres, basalt fibres and carbon fibres, combinations of which may be included in the thermoplastic matrix material.

In certain embodiments, the reinforcement may comprise at least 0.05 wt % and/or up to 60 wt % of the weight of the composite, e.g., the reinforcement may comprise 20 wt % of the weight of the composite. The means of providing the reinforcement, the sizes (e.g., lengths), composition, and weight percentage of the reinforcement of the composite may each be specified to provide a desired material property and/or behaviour of the composite and/or the first pipe layer 14, including the heat distortion temperature. Other desirable material properties and/or behaviours include Young's modulus (stiffness/flexibility) and strength. Inclusion of the reinforcement in the composite improves the creep resistance and/or stiffness of the composite, and hence the first pipe layer 14.

By including the reinforcement in the composite, it is possible to match, or at least minimise the difference between, the material properties of the metallic wires and thermoplastic matrix material. This may improve the mechanical stability of the first pipe layer 14 since improved stress distribution may be exhibited, as stress concentrations at the interface between wires and thermoplastic matric material may be reduced. Improved mechanical stability can provide reduced bonding issues and delamination of the metallic wires and the thermoplastic matric material. Moreover, aligning the material properties may improve the thermal stability of the first pipe layer 14, allowing the first pipe layer 14 withstand temperature fluctuations without degrading or deforming.

The thermoplastic matrix material may be formed from any suitable thermoplastic polymer. Suitable polymers include polyvinylidene fluoride (PVDF), polyethylene (PE) including grades of raised polyethylene of temperature resistance (PE-RT) and cross-linked polyethylene (PEX), polyphenylene sulphide (PPS), polypropylene (PP), a thermoplastic elastomer, and a polyamide. These thermoplastics are commonly used in the manufacture of RTP. The plurality of metallic wires may comprise steel, a metal alloy, or any other suitable metallic material. optionally the metal wires may be coated to assist corrosion resistance and/or bonding to the further thermoplastic matrix material.

The second and third pipe layers 16, 18 may each be made of any suitable material, e.g., one and/or the other, may be a polymeric pipe layer. As such, either of the first and second layer may comprise a polymer, e.g., a thermoplastic polymer. The second pipe layer 16 may provide an impervious liner layer, or an inner barrier layer, providing resistance to a fluid transported through the pipe 10. Suitable polymers for the second pipe layer 16 include high-density polyethylene (HDPE), polyamide (PA), PVDF, PE-RT, PEX, and polyphenylene sulphide (PPS). The third pipe layer 18 may provide a cover layer, or an outer protective layer, protecting the pipe 10 from external environmental factors, e.g., UV radiation and mechanical damage. Suitable polymers for the third pipe layer 18 include HDPE, PP, and PEX. The second pipe layer 16 may incorporate a permeation barrier layer, e.g., a metal film or co-extruded layer of ultra-low permeation polymer such as PPS. In the case of both the second and third pipe layers 16, 18, other polymers are contemplated, and polymer blends may be used.

In certain embodiments, the first pipe layer 14 may be formed of one or more helically wrapped tapes formed of the plurality of metallic wires embedded in the composite. In such embodiments, the benefits described above with reference to the first pipe layer 14 are equally attributable to the tape, e.g., improved heat resistance, mechanical and thermal stability. The tapes may extend helically about the core 20, and/or be wrapped about the second pipe later 16 or an intermediate further pipe layer. The angle of winding, i.e., the lay angle, may be critical for balancing axial and hoop strength in a given embodiment. Hoop winding, sometimes referred to as high-angle winding, may be used, in which the one or more tapes are wound at a high angle, e.g., up to close to 90° relative to a central axis of the pipe 10. This type of winding provides hoop strength, which is essential for resisting internal pressure that tries to expand the pipe radially. Axial or low-angle finding may be used, in which winding is at a lower angle, e.g., closer to the axis, and provides axial strength, which helps resist longitudinal forces such as tension, bending, and external loads on the pipe 10. The helically wrapped tapes may be wrapped having a lay angle of at least 45° and/or up to 90°. At least two of the helically wrapped tapes form respective sub-layers to form the first pipe layer 14.

The first, second and third pipe layers 14, 16, 18 may be any suitable thickness, i.e., radial thickness, depending on the service requirements in a given embodiment. In certain embodiments, the first pipe layer 14 may have a thickness of at least 0.125 inches (˜3.18 mm) and/or up to 0.825 inches (˜20.96 mm). Additionally, or alternatively, the second pipe layer 16 may have a thickness of at least 0.250 inches (˜6.35 mm) and/or up to 0.825 inches (˜20.96 mm), and/or the third pipe layer 18 may have a thickness of at least 0.125 inches (˜3.18 mm) and/or up to 0.375 inches (˜9.525 mm).

The pipe 10 may be manufactured by a method according to an embodiment of the invention. The method comprises forming the flexible pipe 10 by extruding the composite using a mixture of pellets, granules, or similar, of the thermoplastic matrix material and the reinforcement. The first pipe layer 14 may be extruded. Alternatively, extruding the composite may comprise extruding the composite to form the one or more tapes in which the plurality of metallic wires are embedded therein and extend along a length thereof. The thermoplastic matrix material may fed into a hopper, melted and forced through an extruder. The metallic wires may be fed into the extruder to encapsulate them within the thermoplastic matrix material. The wires may be pre-tensioned to maintain proper alignment and reduce bending during extrusion. The cooled and solidified tape may be wound onto spools or further processed, depending on the application. The tape be helically wound around a mandrel or a pipe layer, e.g. the second pipe layer 16, to form the first pipe layer 14.

FIG. 2 shows a flexible pipe 110 according to another embodiment of the invention, in which the first pipe layer 114 comprises two sub-layers 114a, 114b of helically wrapped tape to form the first pipe layer 114. The same, or at least similar, features as described above in relation to the flexible pipe 10 shown in FIG. 1 are denoted with like reference numerals, offset by a factor of 100. The sub-layers 114a, 114b may be wound in opposing helical directions. In certain embodiments, further sub-layers may be provided.

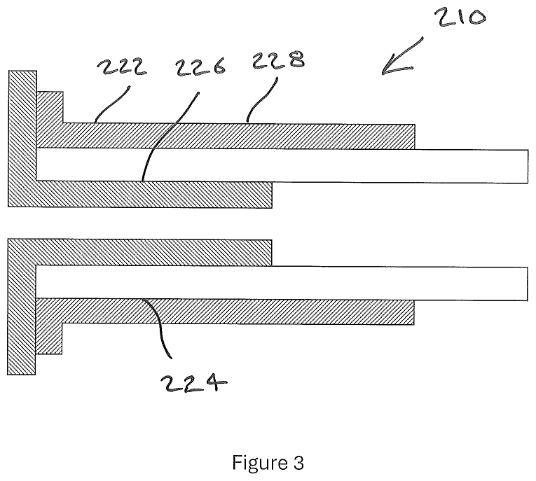

FIG. 3 shows a flexible pipe 210 according to yet another embodiment of the invention. The same, or at least similar, features as described above in relation to the flexible pipe 10 shown in FIG. 1 are denoted with like reference numerals, offset by a factor of 200. The pipe 210 comprises pipe comprising an end fitting 222 to which a first end 224 of the pipe body is connected. As in the illustrated embodiment, the end fitting 222 may comprise a first tubular connector member, or a stem, 226 disposed radially inward of the first pipe layer 214, and/or a second tubular connector member, or a ferrule, 228 disposed radially outward of the first pipe layer 214. The first pipe layer 214 may be configured to be sealingly secured between the first and second tubular connector members 226, 228, through radial swaging, or crimping, or some other suitable means, to effect load transfer between the pipe body 212 and the end fitting 222. Therefore, the first pipe layer 214 may be clamped between the first and second tubular connector members 226, 228.

The invention is not restricted to the details of any foregoing embodiments. In particular, while the illustrated embodiment shows the pipe body 12 comprising three pipe layers any number of pipe layers may be present, including a single pipe layer, two pipe layers, and four or more pipe layers. Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. In particular, the words “certain embodiments” are to be understood to mean any embodiment described, illustrated, or otherwise disclosed herein, unless expressly stated otherwise. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

Attention is directed to all papers and documents which are filed concurrently with or previous to this specification in connection with this application and which are open to public inspection with this specification, and the contents of all such papers and documents are incorporated herein by reference.

1. A flexible pipe for conveying oil and gas field fluids, the pipe comprising a pipe body comprising a first pipe layer formed of a plurality of metallic wires embedded in a composite, the composite comprising a thermoplastic matrix material and a reinforcement dispersed therein,
wherein a heat distortion temperature of the composite is at least 200° F. (˜90° C.) when tested in accordance with ASTM D648 using an outer fibre stress of 0.455 MPa.

2. A flexible pipe according to claim 1, wherein the reinforcement comprises at least one of a plurality of long fibres having a fibre length greater than 1 mm and/or a plurality of short fibres having a fibre length of up to 1 mm.

3. A flexible pipe according to claim 2, wherein the plurality of short fibres and/or long fibres comprises one of aramid fibres, glass fibres, basalt fibres and carbon fibres.

4. A flexible pipe according to claim 1, wherein the matrix material comprises one of a polyvinylidene fluoride, a polyethylene, a polyphenylene sulphide, a polypropylene, a thermoplastic elastomer, and a polyamide.

5. A flexible pipe according to claim 1, wherein the first pipe layer is formed of one or more helically wrapped tapes formed of the plurality of metallic wires embedded in the composite.

6. A flexible pipe according to claim 5, wherein at least two of the helically wrapped tapes form respective sub-layers to form the first pipe layer, the sub-layers being wound in opposing helical directions.

7. A flexible pipe according to claim 1, wherein the pipe body comprises a second pipe layer disposed radially inward of the first pipe layer.

8. A flexible pipe according to claim 7, wherein the second pipe layer is a polymeric pipe layer and/or provides an impervious liner layer.

9. A flexible pipe according to claim 1, wherein the pipe body comprises a third pipe layer disposed radially outward of the first pipe layer.

10. A flexible pipe layer according to claim 9, wherein the third pipe layer is a polymeric pipe layer and/or provides a cover layer.

11. A flexible pipe according to claim 1, wherein the pipe comprises an end fitting to which a first end of the pipe body is connected.

12. A flexible pipe according to claim 11, wherein the end fitting comprises first and second tubular connector members disposed radially inward and outward of the first pipe layer, respectively, the first pipe layer being clamped between the first and second tubular connector members.

13. A use of a flexile pipe according to claim 1, as an onshore pipe to convey an oil field fluid or a gas field fluid, and wherein optionally the flexible pipe is a reinforced thermoplastic pipe.

14. A method of manufacturing a flexible pipe for conveying oil and gas field fluids, the method comprising:
forming a flexible pipe according to claim 1, the forming including extruding the composite using a mixture of pellets of the thermoplastic matrix material and the reinforcement.

15. A method according to claim 14, wherein extruding the composite comprising extruding the composite to form a tape in which the plurality of metallic wires are embedded therein and extend along a length thereof.
